(19) United States
(12) Patent Application Publication
(10) Pub. No.: US 2010/0033015 A1
(43) Pub. Date: Feb. 11, 2010

(54) Unitized Electric Generator and Storage System - Combined Hydro Turbine and Solar Powered Electrical Storage System

(75) Inventor: Raymond Alvarez, Goodyear, AZ (US)

Correspondence Address: LAW OFFICE OF KEN DALLARA;KEN DALLARA, 4052 Eagle Flight Drive, SUITE 100, SIMI VALLEY, CA, 93065, US

(73) Assignee: TECHSTREAM CONTROL SYSTEMS, INC, Goodyear, AZ (US)

(21) Appl. No.: 12/537,251

(22) Filed: Aug. 6, 2009

Related U.S. Application Data
(60) Provisional application No. 61/087,090, filed on Aug. 7, 2008.

(51) Int. Cl. H02J 3/38; H02J 7/35

(52) U.S. Cl. 307/72; 320/101

(57) ABSTRACT

A unitized electrical generating and storage system is herein described that combines up to three sources, hydroelectric, solar and wind, of that can produce electric power. This invention encompasses an enclosed housing structure that securely and efficiently integrates multiple power generating technologies and electrical storage capacity into a single platform assembly or unit that is easy to install and implement. It can be applied to a variety of applications and locations where conventional utility power or a single renewable energy source can not be reasonably incorporated. This invention is designed to address the electrical needs of remote sites or locations where other power supply facilities or means are non-existent or difficult to impossible to implement and creates more aesthetic power generating equipment to sites along highways, roads, parks, golf courses, rivers, lakes and reservoirs. It also provides an ecological alternative to other less environmentally friendly power generating or supply options.

### CLAIMS OF PRIORITY

This application claims priority from provisional application 61/087,090 filed in the name of inventor Raymond Alvarez entitled Unitized Electric Generator And Storage System filed on Aug. 7, 2008 and is currently pending.

### SUMMARY OF THE INVENTION

This invention involves a housing structure assembly and components for the purpose of producing electric power as a complete production and electrical storage system. Electric power energy, as herein described, is developed from a combination of renewable energy sources and is monitored, regulated and managed electronically. Power generating sources include the utilization of a hydroelectric turbine power generating unit, photovoltaic collector or solar collector panels and, optionally, wind power generation that are capable of working simultaneously or at different times to produce electric energy. The unitized electric power generating system, as provided, functions as a complete integrated assembly contained in a single chasse housing or enclosure structure. Embodied as a unit, this invention can be utilized in remote locations where electric power is needed, but conventional utility power is unavailable or impractical. And, where there is a supply of water flowing through a pipe under hydraulic pressure that can be used to operate a hydroelectric turbine generator system, and where photovoltaic or solar energy production is possible using collector panels and where there is sufficient wind energy which can be incorporated to operate a wind turbine electrical generating system and all at a single physical location.

### BACKGROUND OF THE INVENTION

There are a multitude of different renewable energy system designs that include hydroelectric, solar power, wind power and others that are intended to provide an eco-friendly means of meeting certain energy needs or requirements. Each focuses on a particular method of collecting energy and usually involves a specialized device that is designed to extract as much power from the source as efficiently possible. Such designs are well publicized and documented, and are usually popular because of the economical capture and utilization of naturally occurring forces or the ecological benefit to the environment. In either case, renewable energy is typically recognized as being far more preferable to other methods that may pollute or have a negative impact on the environment, either directly or indirectly.

In respect to the development of renewable energy systems or the evolution of these technologies, most of the efforts today are directed at improving upon existing designs and making them more efficient and productive. That is, naturally occurring forces that serve as the initial power supply means have been in existence since the beginning of time and have been well recognized with attempts at organizing and harnessing them for useful purposes. Most contemporary designs seek to improve upon older discoveries and typically center on more power production.

The basis for a useful design focuses of the economy and ecology of the product. However, other considerations can be the aesthetic impact the device might have to a particular area or whether there are sufficient natural energy forces available to justify applying a certain energy production or generation means. In such cases, utility power is normally the solution since it can be concealed, to an extent, if the power cabling is buried or if a naturally occurring supply is not sufficient to meet the demand need. Frequently there may be multiple kinds of naturally occurring power supply resources available at a particular location like water flowing under pressure whether by gravity of sustained pumped pressure, wind or solar energy. A combination of renewable energy resources may be available for utilization that could, when combine, be enough to replace or justify not using less economical and environmentally friendly metered utility power.

U.S. Pat. No. 6,559,552; by Ha, its inventor, explains a system of utilizing a combination of rain, wind, wave and solar power generation (“4 in 1”) as a single integrated system. The patent explains the ability to produce power by utilizing all four natural resources or just ones that may be readily available. The advantage of this concept is that it is a convenient way of assuring maximum power production using all available resources the apparatus is designed and capable of utilizing. This invention would, of course, be most effective in an environment that had an abundance of the natural resources it references and would loose its effectiveness the farther it was removed from a geographic region that had them all, like along an ocean coast line, a stream or river.

Additionally, U.S. Pat. No. 7,246,492; by Hendrix, its inventor, explains a complex steam and hydroelectric power system whereby solar radiation is collected to heat water to produce steam. A hydroelectric turbine generator is also explained that is supplied water flow from the steam turbine's condensation reservoir or tank. The patent teaches that in addition to solar power that is used to heat water to convert to steam energy thereby driving a steam turbine unit, the subsequent steam condensation is then collected and returned to liquid water and dropped via an elevation difference to create head pressure needed to propel a hydraulic turbine. The hydraulic turbine also produces electricity, as the patent claims. Water from the steam chamber can be supplemented with rain or other forms of flowing water to operate the hydroelectric turbine. The patent also describes that solar radiation needed to heat water can be supplemented with natural gas or other organic combustible materials should solar energy not be present or sufficient to generate steam.

Similar to Ha's invention, this product involves multiple power generation methods, but has obvious limitations as well in that the temperatures needed to develop enough steam to be useful would be difficult to attain using solar energy alone. The use of other combustible fuels to supplement solar energy defeats economic and eco-friendly objectives common to most renewable energy generation systems as stated earlier. Furthermore, the amount of steam and hydraulic head pressure needed to operate both the steam and hydroelectric turbines would be substantial in terms of volumetric capacity. If the water supply was primarily dependant upon the steam to water conversion recycling reservoir the patent describes, it would need to be of a tremendously large size otherwise the apparatus would likely be required to utilize an alternative water supply source on a regular basis. Since the recycling reservoir would need to be of such significant volume to supply the hydroelectric turbine, the solar collection capability would also need to be of a substantial quantity and area in order to achieve the temperatures needed heat water to create steam. The enormity or shear size of the design needed to fulfill the operational requirements and performance of this combined power generation system is its greatest limitation and would restrict the locations it could be implemented.

There are numerous small applications where a unitized renewable power generating system would be beneficial. Powering electronic control systems and possibly lighting in municipal or institutional landscaped areas along roads and highways, parks, easements or other similar properties like golf courses where placing an electric meter or cabling can be quite expensive and prohibitive. Such properties typically incorporate electronic control features so as to better manage irrigation water resources so implementing a renewable energy supply is consistent with that concept. There are agricultural applications that would also be well suited for a unitized system. Furthermore, piped irrigation typically involves water that flows under hydraulic pressure which provides an opportunity to capture, at least, a portion of that energy to produce electricity using a turbine generator system. Additionally, landscapes of all kinds, golf courses and agricultural farming nearly always do best in sunny environments and are ideally suited for implementation of solar electricity production.

Remote locations such as along pressurized fluid flow pipe lines in any region and where monitoring of said fluids relative to flow and pressure are critical to managing transfer operations. Since such management components can involve flow and pressure sensors, data logging or other SCADA type functions that require electronic circuitry, remote communications and logic, electricity must be readily available to provide power.

Similarly, booster or lift pump systems that require electric energy to operate could be powered by a unitized electric power generating system. Energy needed to supply an electric pump that is required to continue the conveyance of water, for example, through a pressurized main line could be supplemented by utilizing renewable energy resources like solar or wind energy or the added weight and subsequent pressure or hydrostatic build-up of water flowing through a pipe down and steep hill. Sufficient energy could be gleaned from these resources, and when combined, would provide a cost effective and environmentally sound alternative to metered utility power.

What is needed then is a scalable, unitized, combined electrical power generating system that incorporates multiple natural resources that, when working together or independently, can produce electricity in a multitude of locations whether urban, suburban, rural or any regional environment. What is needed then is a system that can be easily adapted and installed in a variety of areas where electric power is needed to supply electronic systems and/or facilities with electrical needs and in replacement of metered utility power or other singular renewable power generation methods.

### DESCRIPTION OF THE INVENTION

The following description is a single illustration of how this invention could be embodied; however, it is not by way of limitation or omission of the Claims restricted to this embodiment only. Other embodiments will become obvious to those skilled in the art without deviating from said Claims. A solution is herein devised in this invention to address local electrical power supply needs, whether large or small, of areas where the method and design of this invention can be implemented. Specifically, this invention relates to the generation of VAC or VDC electric power produced and derived from a hydroelectric turbine generator as the main and primary power generating source, solar or photovoltaic energy collection and wind energy means as separate elements that can be added to the main primary generating source and wherein all are combined in a single, scalable, unitized apparatus or chasse housing structure. Said structure is designed as an assembled unit that securely combines the necessary parts and equipment needed to produce and store electricity.

The main or primary electrical generating component of this invention provides an efficient means of producing energy from fluid flowing under pressure using a small or miniature hydroelectric turbine generator device. Regardless of which other device, solar collector or wind turbine or both together are implemented, the hydroelectric generator is foundational to the design and will always be implemented with at least one or both the other two generating means.

Therefore, this invention will typically be implemented and in physical connection to a pipe line that flows a fluid, such as water, under hydraulic pressure and wherein said fluid is used to, wholly or in part, propel the turbine generator system explained by this invention. This invention shall further be implemented in regions or locations where there is sufficient sun light to produce solar energy and/or atmospheric wind to produce wind turbine energy. Solar or wind power is implemented in this invention alternatively or together and in combination with hydroelectric turbine power to produce the system of this invention.

Said turbine generator system can include, but is not limited to, the invention submitted for U.S. patent application by the same inventors, Alvarez/Gilson; application Ser. No. 12/014,659, Reduced Pressure Differential Hydroelectric Turbine System, and application Ser. No. 12/014,651, Methods for creating a Low Fluid Pressure Differential Electrical Generating System, by the same inventors. The invention explained in these filings relate to a hydroelectric turbine unit that specifically addresses the challenges of sustaining downstream fluid flow and pressure to assure the continued movement of fluid trough a pipe after it has been discharged from the turbine device, while at the same time, producing a particular amount of electric energy to supply local needs.

This invention is comprised of both an above ground surface chasse housing structure, which can be vandal and theft resistant by design, mounted atop of a sub-surface storage structure or vault. The unit is generally four sided with a top surface that contains access doors or removable panels that permit service and maintenance of internal components. Photovoltaic solar collector panels are securely mounted atop of the above-surface chasse portion and the hydroelectric generating device is mounted within it. Both the above-surface and sub-surface portions of the structure can be a single complete unit or assembled in multiple pieces.

The assembly can omit the photovoltaic collector panels or wind turbine generator and any other unnecessary components related to those items depending upon the requirements of a particular application. For example, in a fluid transfer system located in a mostly sunny region and where fluid flow and solar energy production opportunity is continuous, but regular wind supplied energy is not, the turbine generator and solar collection devices would be included to supply all electrical requirements. Therefore, a wind turbine would not be necessary to add to the housing structure.

The entire assembly is installed over the top of or in proximity to a pressurized main, or sub main, pipe line that contains fluid flowing under pressure. The pipes are connected to the hydroelectric generator device that is mounted under the cover of the above-surface chasse or housing portion. The structure can contain flow by-pass lines and control valves to regulate direction of flow through the system and to regulate inlet pressure. Fluid flow by-pass lines, control valves or actuators, flow and pressure sensors can also be contained either within the above-surface chasse portion, or within the sub-surface portion of the housing structure assembly.

By way of illustration, but not limitation, a hydroelectric generator provides power when fluid is flowing under pressure through a pipe, and when the fluid flow or pipe system that is controlling and requiring it is in fluid flow operation. Fluid flowing through a pipe provides sufficient power to supply the entire electronic control system during operation and to recharge its batteries. The photovoltaic collector panels and wind turbine generator also recharge batteries, but during periods of none flow operation or when the hydraulic turbine system is idling, generally. Thus, the system is able to generate significant energy to operate electronic components and other electrical devices both during prescheduled fluid flow durations or when idling in “off” mode. Therefore, the system is not wholly dependant upon one energy source over another, though fluid flow is the primary and most significant energy production source in this invention.

Various electronic monitoring and control devices like Supervisory Control and Data Acquisition (SCADA) products or other components like inverters, transformers, power supplies for outdoor lighting, communication equipment that require or use power can be housed within the chasse housing structure to create a completely self contained system. Electronic control units or controller devices, data logging or sensory recording devices, remote monitoring units, sensor interfaces or any other devices that can be powered by the system can also be housed within this invention. Batteries are preferably housed within the sub-surface vault portion of the structure where cooler ambient temperatures would be more favorable to extended battery life. Both the above ground and below ground chasse portions can be constructed of heavy plastic or poly type materials, fiberglass or other composite materials, steel or stainless steel or any combination of these items.

The hydroelectric turbine generator unit will typically be classified as a small or miniature turbine unit and is comprised of a generator device, which can include alternators, electric generators or DC electric motor units or any other device that when its generating shaft is turned or rotated repeatedly produces electric voltage and current. The generator unit is connected to a turbine unit that includes an impeller or similar device that is capable of converting kinetic energy from flowing fluid to rotate the generator's shaft. As water flows through the pipe and across the turbine impeller under pressure, the impeller is moved thus turning its shaft that can be shared with the generator device. The turbine's impeller shaft can be commonly shared with or coupled to the generator, or can be connected via a pulley or gear apparatus to increase shaft turn velocity. As the impeller shaft rotates the generator's shaft, the generator produces electric voltage and current. The hydroelectric turbine generator is preferably attached or housed within said chasse housing structure.

The hydroelectric turbine explained by this invention is capable of producing and supplying either VAC or VDC electric voltage and current depending upon the type of generating device selected to operate with the system and the demand requirement.

Most any photovoltaic or solar panels can be incorporated in the system and are mounted either on the top-side of the housing chasse structure for the purpose of achieving the best angle and position relative to the sun for optimal production of electricity. Solar collector panels that are mounted on top of the housing are securely attached and protected from vandalism. Clear transparent materials, like lexan or similar product, can be incorporated as a protective shield to cover said panel area surfaces. Or, said panels can be mounted atop of a mast that is attached to said housing chasse structure to better position said panels higher above the ground surface to achieve greater solar exposure.

A mast structure can also be utilized to mount wind turbine generator to the housing unit as well as solar panels. The mast design mounts directly to the housing structure or chasse and can be of a collapsible design to allow easy installation and service. The mast is permanently mounted, detachable or removable but is always attached to and is in connection with the housing. The mast is capable of serving as a mounting platform for antenna that may be utilized with the RF communication element of a control system integrated for use with the power generating system or a separate electronic system contained within said housing. It can also be used to attach sensor arrays for various atmospheric sensors or weather stations. All power cables and cabling for any other items connected to the mast are routed inside and concealed within the mast structure which is constructed of aluminum, steel, stainless steel, plastic, fiberglass or composite materials or any combination of said materials.

The mast structure includes mounting hardware that allows it to be conveniently assembled and disassembled as the need requires, it is constructed so as to minimize susceptibility to theft and vandalism. There are upper and lower mounting points that include a hinge or pivot point at the bottom of the mast pole to allow the structure to be erected vertically for functional operation or laid down for access or servicing. Upper mounting hardware allows the mast to be securely fastened to the housing when the mast is in its permanent fixed position. All cabling that passes through the mast's interior also passes through the inside of the mounting hardware to further conceal from exterior view.

A wind turbine unit that is incorporated with this invention can be of any popular make or type with blades or vanes and are positioned on the mast to take the greatest advantage of wind direction and speed so as to efficiently generate as much electric energy as possible. The wind turbine shall be elevated above the ground surface and securely attached to the mast structure to assure it's safe operation and to discourage unauthorized tampering or vandalism and to best avail air movement and its contact with its blades. Each unit shall contain an electronic monitoring and control system that can include either analog or logic based digital processor elements such as a SCADA system. The automated monitoring and control functionality includes the abilities to detect or sense fluid flow and pressure contained within the hydraulic pipe line the system is operating with, electrical state, electrical loads and electrical power output. The system also contains a field user interface and the ability to initiate and execute user defined programmed functions such as, but not limited to, scheduled tasks or events, establishing thresholds and limits, manual operations, and automated logic based algorithms designed top modify or adjust, in real time, various system performance elements based upon information supplied by sensor inputs. The system is additionally capable of interfacing or functioning with various exterior systems using a variety of remote communication means including all digital and analog communication protocols and electronic circuitry that enables direct hardwire, fiber or light, radio frequency, cellular or telephone lines. This portion of the invention can be integrated to function with other electronic devices like PCs, laptops, PLCs handheld PDA, WAP type devices or other electronic systems.

Electronic circuitry of the control system explained by this invention includes electronic components and imbedded software features required to monitor and regulate generated electric current and voltage between all critical elements which comprise the system, such as between turbine generator, photovoltaic panels, batteries, inverters, sensors and the electronic devices that are being powered and herein described. The system shall possess the ability to display or report system status or other critical states or conditions on a panel or board within or outside the chasse housing. Information such as voltage and current production and consumption measurement levels, battery charge state, fluid flow rate and pressure including differentials, valve solenoid or actuator position and electrical current draw for output circuits are obtained and processed the control system. The system shall have the capacity to interface through various digital or analog communication means with other exterior monitoring and control systems. Such systems can include a dedicated or none dedicated control unit, software in a PC or laptop or other graphical user interface means like portable wireless appliances, cell phones or hand held units containing special embedded firmware or software. The system herein described can be either wholly, or in part, be powered by VAC or VDC electric voltage and current.

The control system explained by this invention can include other functions not directly or necessary to operate this invention and can include integrated features such as, for example but not limited to a remote monitoring or data telemetry system like a data logging system, a remote video surveillance system and radio or cellular repeater system or an irrigation control system. Control functions, as provided, would be able to turn various electronic or electromagnetic devices like solenoids, actuators, servo motors or relays on or off at preset, predetermined times or intervals, according to date time or calendar schedules or according to information obtained through the implementation of various sensor inputs. Other sensor inputs can be incorporated that include atmospheric or weather related, soil moisture content, motion detection, thermal temperature and others. A unique element of this version of the control system as herein described by this invention is that it can either wholly, or in part, be powered by either VAC or VDC electric voltage.

Providing a full featured VDC powered control system eliminates the need for an inverter and would significantly increase energy efficiency. Inverters typically require a substantial amount of power and would not be necessary for a VDC powered system since the energy producing elements of this invention hydroelectric turbine, solar panels and wind energy generators can all produce VDC power. The benefits and features contained in a VDC powered system would surpass that of other VDC or battery powered control systems. The power generating capacity of this Unitized Electrical Generating and Storage System would far exceed the capacity of current VDC powered systems that are used in comparable applications and that incorporate only one method of electrical generation as opposed to the three combined in this invention.

The Unitized Electrical Generating and Storage System taught by this invention is capable of providing VAC or VDC electric power alternatively or together. Inverters may be incorporated by either a portion of or all the power production elements herein explained which comprise this system.

### APPLICATIONS

By way of example and not limitation, a Unitized Electrical Generating and Storage System that incorporates a miniature or small type hydroelectric generator and solar panel electric power supply system can be used in a variety of applications including landscape irrigation systems, golf courses, pump controls, swimming pool or pond recirculation, public water works or water transfer systems, petroleum, gasoline, natural gas among others. This invention is intended to provide electric energy to locations where bringing conventional metered utility power is impractical, cost prohibitive, impossible or as an environmental alternative to utility supplied power. Furthermore, the system as a complete unitized assembly, can be easily and inexpensively installed in the most challenging or difficult locations.

The system can be installed in locations where utility power may be available but not cost competitive or as ecologically conducive. For example, in a municipal park or public landscape right-of-way or planter island in a road, a system can be installed to furnish power to an entire irrigation system including electronic controller units, field sensors, remote communications and valve solenoids, actuators or relays. Water flowing through the same main line as that that supplies the landscape is used to power the entire system with enough reserve power to recharge batteries. Photovoltaic collectors provide additional supplemental power during idle time operation or during long periods when hydroelectric power is unavailable and when scheduled watering may not be necessary.

Since the pressure of most public water systems that supply irrigation must be regulated down or reduced to provide proper pressure to sprinkler heads, utilizing the excess pressure to create electricity instead is a logical alternative to wasting it. Most drip type or spray head irrigation systems require very little pressure so converting the available energy in the form of excess pressure into electric energy rather than diminishing it has substantial economic benefit.

Other applications of where the generator system can be incorporated are in industries where moving large amounts of any fluid through pipe lines that span long distances. Units can be deployed at any point along the fluid flow transit system or pipe line and serve as a discrete power generating source for electronic components like a remote monitoring and control stations as explained, or can supply remote facilities, lighting or any other industrial, commercial, public or private requirements that use electric. Dimensional size variations in terms of available power generating resources, (like fluid flow pressure and volume, sun light and wind), and supply demand requirements will dictate the scale or physical size of the design of this invention. Since the system encompasses a secure vandal resistant chasse structure, it can be placed in unfriendly environments where large solar panels or conventional electrical wiring may be attractive targets for unsavory individuals or thieves.

The primary objects of this invention are to first, effectively combine all necessary components and devices into an easy to install and maintain secure chasse structure or housing unit. Secondly, provide a single system that combines hydroelectric generated power, photovoltaic or solar power and atmospheric wind energy to supply electricity to a battery and other electric or electronic devices. Third, provide an economical, constant and consistent electric power supply that can be implemented as an alternative to more expensive conventional utility power or other singular renewable power supply sources.

### DESCRIPTION OF THE DRAWINGS

The following description and the figures to which they refer are provided for the purpose of describing examples and select embodiments of the invention only and are not intended to exhaustively describe all possible examples and embodiments of the invention. Many specific implementations of the following described system will be apparent to those skilled in the art.

FIG. 1; Horizontal Housing Assembly

FIG. 2; Horizontal Housing Assembly Cutaway

FIG. 3; Vertical Housing Assembly—Side View Cutaway

FIG. 4; Vertical Housing Assembly—Top View

FIG. 5; Vertical Housing Assembly—Side View Cutaway

FIG. 6; Flow Chart

It is understood that in this detailed description of the drawings that all devices will be presented in the singular form. The singular form is used generically to imply either a singular device or a plurality of similar devices can be used in the described situation, meaning, for example, that when a solar panel is described, the scope of this invention covers a single solar panel or multiple solar panels.

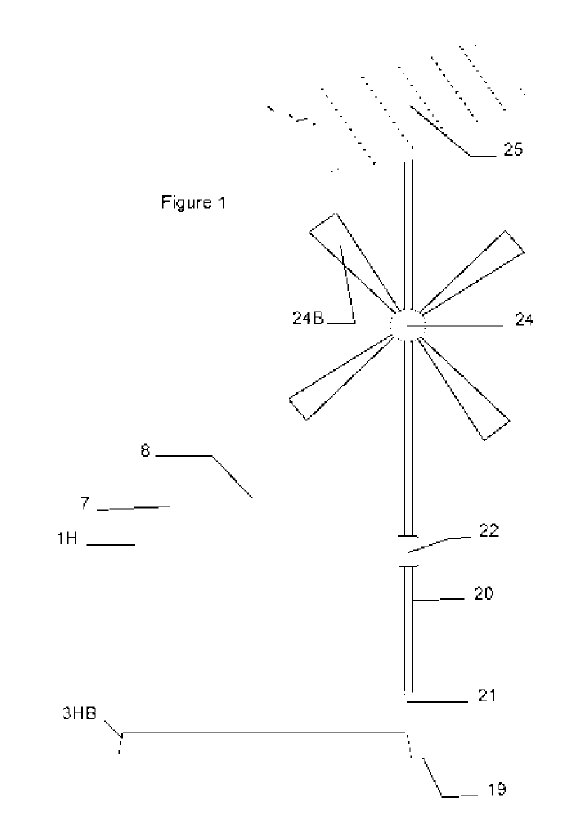

FIG. 1 shows the above ground level portion of the invention as an assembled horizontal housing structure. The structure (1H) is either removably or permanently attached to the mounting base (3HB) which include the sub-ground surface structure portion (not shown). The mounting base (3HB) is located at ground or slightly above grade level (19) and provides a secure and stable mounting platform for the entire above ground portion of the assembly (1H) and all that is commonly attached to it. The Housing structure (1H), which includes an exterior and accessible and lockable interior area. The interior area houses the componentry of the apparatus, including power generating means and the control system necessary for the operation of the apparatus. The housing structure contains at least one hydroelectric turbine generating apparatus located within the interior area (not shown), and further can affix solar collector panels or solar panels (7) on the exterior area top portion of the housing and can include a clear protective cover (8); further, a mast structure assembly (20) which attaches solar panel (25) can be swivel or adjustably mounted and affixed atop mast that can be connected or affixed to the housing (1H) by utilizing mounting hardware (22) and (21) that allows the mast to be mounted either permanently or removably from the Housing structure (1H). A wind turbine electrical generator device (24) can be optionally attached to the mast if environmental conditions are suited for the use of such a device. The mast would be of sufficient length to allow clearance and security for rotating wind turbine blades (24B) and could either be positioned below, as pictured, or above solar collector panels, which also share the mast. The wind turbine and solar panels could also be affixed to separate masts so that neither device operates from the same mast. However, regardless of whether a single or multiple masts are incorporated, both masts would be in direct physical communication with said housing structure (1H).

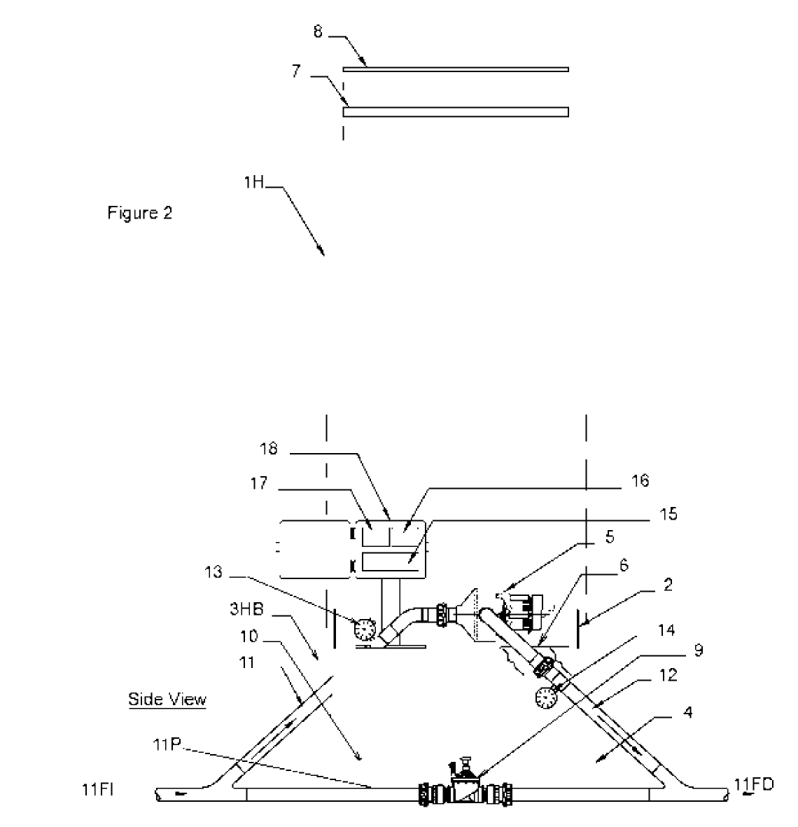

FIG. 2 shows an above and below ground level view of the horizontal housing structure assembly. The below grade level base portion (4) is placed within a large hole dug or excavated below ground level and is positioned over the top of a sealed pressurized fluid flow pipe line (11P). The hole or excavation is refilled and the soil is compacted around the below grade level portion to securely hold it in place once the housing assembly is functioning and operable. The below grade base portion (4) and the mounting base (3HB) are in physical connection with one another by the use of bolts, hinges, pins or other types of securable or lockable hardware. Said pipe line, such as a water main for example, can include automatic or manual control valves (9) to divert or otherwise control the flow of water (11FI) that moves into the system or into a by-pass pipe line (11) that diverts fluid flow (11FI) into the hydroelectric turbine generator unit (5) for the production of electricity, then discharges the flow (11FD) into a sealed discharge pipe (12) which is again attached to the main pipe line (11P) to allow the discharged flow (11FD) to continue moving through the line. Pipe lines can also include pressure sensors (13) up the flow stream of the inlet pipe (11) and down stream (14) in the pipe which discharges flow (12) to provide information like how the turbine unit is affecting pressure loss through the fluid flow system or pipe line network. Similarly, flow sensor (not shown) could be implemented to provide additional information as to the state of the fluid flow system the turbine unit is operating with. The turbine would ideally make physical connection with pipe lines (11 and 12) by use of pipe unions or removable couplings (6) to allow for easy and convenient removal and servicing. The hydroelectric turbine generator (5) can either be located or attached within the below ground base portion (4) (not shown) wherein said turbine generator can be mounted and supported by the pipes (11 and 12) that it is in physical connection therewith, or can be supported and affixed to the below grade or ground level base portion (4) (not shown), or can be mounted above the below grade base portion and affixed to the top of said mounting base (3HB) (shown), or can be attached to the interior portion of the housing (1H) (not shown). Capacitive electrical energy storage device such as batteries (10) as singular or in multiple banks, can be housed within either the below grade level portion (IV) or above and within the interior portion of the housing (1H). Vertical mounting braces or attachment points like hinges or hardware that can be bolted or the like (2) are affixed to the mounting base (3HB) and serve as the attachment point between the housing (1H) and the mounting base (3HB). The housing structure (4) is ideally removable or can be opened to permit access into it's interior space to allow easy and convenient access and servicing of all interior components and devices. Solar panels (7) with optional protective transparent covers (8) can be affixed to the top portion of the housing (1H) and/or be mounted on a mast, as explained in FIG. 1, and adjustably positioned and directed toward the sun to maximize solar energy production. The horizontal housing structure (1H) can also accommodate electronic devices that monitor and control the overall system operation, like charge controllers (17), voltage and current regulators (16), inverters (15) or other specialized power supplies or SCADA system devices or other electronic devices that would receive power from this invention. These electronic devices can be electrically connected via hardwiring to the monitors and/or controllers or can be electrically connected wirelessly providing for possible external monitoring, communication and control of the units. The hydroelectric turbine generator (5) produces electric energy as fluid flows through it and conveys that energy via a wire or cable path to a voltage regulator and/or inverted if the regulator is integrated into the turbine. Similarly, solar collector panels (7) and wind turbine generator (not shown) would also provide electric energy when solar or wind conditions are suitable and potentially when hydroelectric turbine power is unavailable and would also be in wire or cable path communication with a voltage regulator or controller.

Both VAC or VDC electric voltage and current can be produced depending upon the requirement by implementing appropriate electronic hardware like inverters or transformers. In the preferred embodiment, energy from the turbine (5) and solar panels (7) or wind turbine (not shown) would be directed to capacitive electrical energy storage device (10). In this embodiment, a battery (10) or set of batteries are used as a capacitive electrical energy storage device, for storage and use by any electronic devices that are supplied power by this invention. FIG. 2, by way of illustration and not limitation, explains the implementation of both hydroelectric turbine and solar power energy production and storage, but excludes wind turbine electric power production.

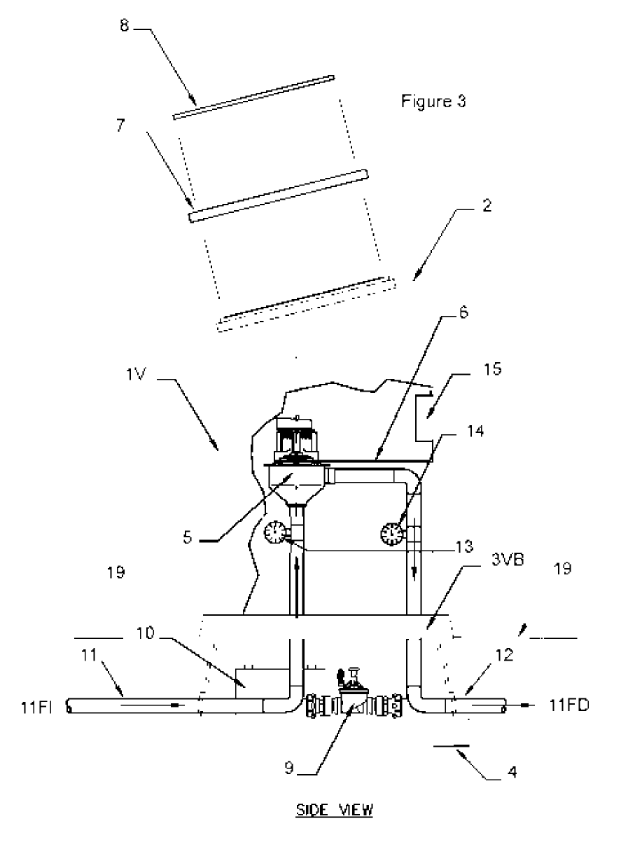

FIG. 3 shows a side cutaway view of a vertical housing assembly. Similar to FIGS. 1 and 2, which could contain nearly identical componentry and functionality, this embodiment seeks to minimize ground surface area by stacking the design vertically to reduce its mounting foot print area. Though not shown, the turbine generator (5) would preferably be located and mounted in the interior space of the housing (1V) in a position that allows for the utilization of 90 or 45 degree pipe sweeps rather than 90 degree elbows or street ells. Utilizing pipe sweeps rather than couplings or adaptors that make hard 90 degree turns or bends in the pipe will minimize pressure loss normally attributable in such designs. Again, similar to FIG. 2, the hydroelectric turbine generator can be mounted either within the housing (1V) attaching to an interior wall by the use of a mounting bracket (6) or other mounting hardware design, or can simply be supported by the pipe (11) and (12) the turbine (5) is connected and functioning with, or can be located or position within the below grade mounting base portion (4). Positioning the turbine (4) within the interior space of the below grade housing portion (4) would increase usable interior space within the housing structure (1V) to permit the placement and implementation of additional electronic equipment or other devices that would benefit from the increase in interior volumetric area. The housing structure (1V) is preferably bolted down to or otherwise in physical connection with the mounting base (3VB), and wherein said mounting base (3VB) is bolted down or otherwise in physical connection with said below grade mounting base (4), and wherein said below grade mounting base (4) is positioned within a hole or excavation made below ground level (19), and said hole or excavation is backfilled and compacted to securely fastened the base in the ground once the housing assembly structure (1H) has been attached, and wherein said mounting base (3VB) is positioned at or above grade level (19), and wherein said housing structure (1V) is positioned in a vertical orientation above the mounting base (3VB). In one preferred embodiment, the housing structure (1V) includes a top hatch or lid (2) that can be connected to said housing structure (1V) via hinges for convenient access into the interior space of the housing or by removable or detachable hardware that permits the complete removal of the lid or hatch (2). Access doors or removable panels (not shown) can be incorporated on any of the vertical sides of the housing structure (1V) to permit access into interior compartments or partitions. The lid (2) can serve as the mounting structure or point where solar collection panels (7) can be removably or permanently affixed, and can include an angled top portion from the vertical orientation of the housing structure (1V) so as to allow the solar panel better reception or position in regards to the sun to maximize solar energy electric production, Said solar panels (7), which can include an optional transparent protective material (8) can be mounted either beneath the lid cover (2) or on top of it (not shown). Additionally, the housing structure (1V) can be adapted to accommodate a mast structure, as shown and explained in FIG. 1, that allows for the convenient addition of additional solar panel units and optionally a wind turbine electric generator. The vertical housing structure (1V) can also accommodate electronic devices that monitor and control the overall system operation, like charge controllers (17), voltage and current regulators (16), inverters (15) or other specialized power supplies or SCADA system devices or other electronic devices that would receive power from this invention. The hydroelectric turbine generator (5) produces electric energy as fluid flows through it and conveys that energy via a wire or cable path to a voltage regulator and/or inverted if the regulator is integrated into the turbine. Similarly, solar collector panels (7) and wind turbine generator (not shown) would also provide electric energy when solar or wind conditions are suitable and potentially when hydroelectric turbine power is unavailable and would also be in wire or cable path communication with a voltage regulator or controller.

Both VAC or VDC electric voltage and current can be produced depending upon the requirement by implementing appropriate electronic hardware like inverters or transformers. In the preferred embodiment, energy from the turbine (5) and solar panels (7) or wind turbine (not shown) would be directed to a battery (10) for storage and use by any electronic devices that are supplied power by this invention. FIG. 3, by way of illustration and not limitation, explains the implementation of both hydroelectric turbine and solar power energy production and storage, but excludes wind turbine electric power production.

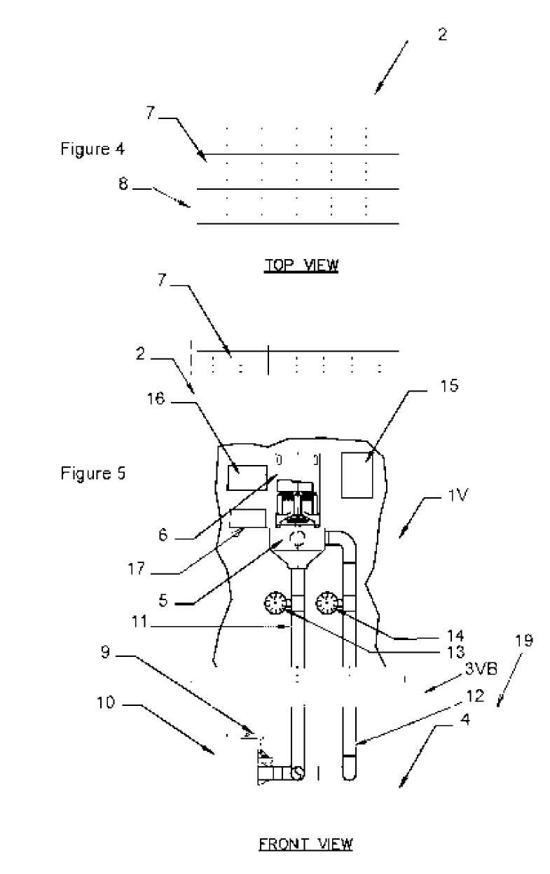

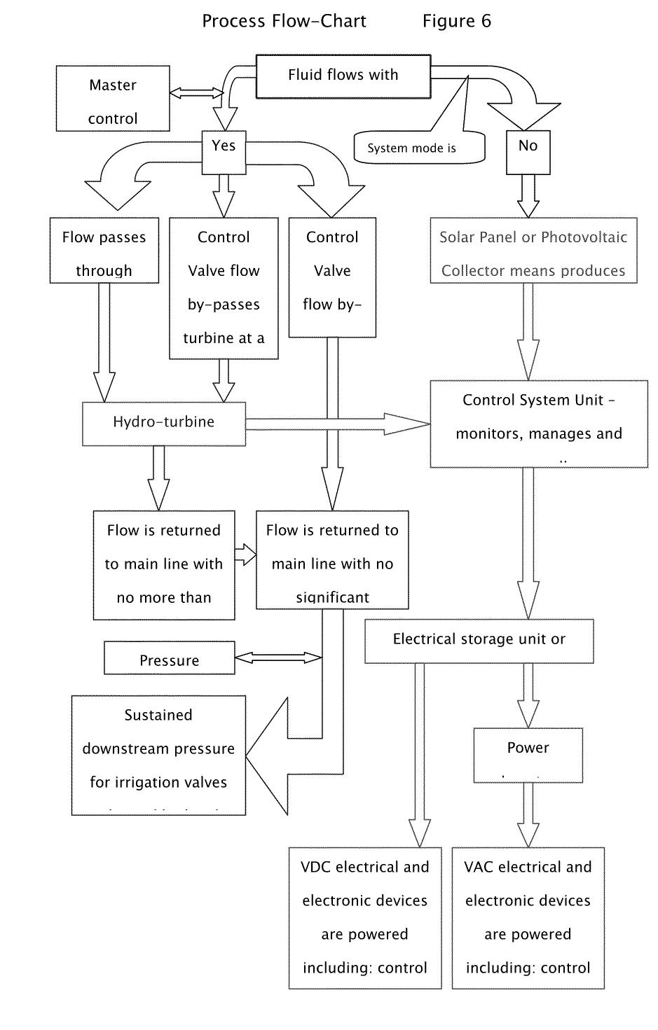

FIG. 4 is a top view angle of the vertical housing structure assembly and shows the position of a single solar panel (7) located on the lid or lockable hatch or door cover (2).

FIG. 5 is a front view angle of the vertical housing structure assembly and similar to FIGS. 1 and 2, which could contain nearly identical componentry and functionality, this embodiment seeks to minimize ground surface area by stacking the design vertically to reduce its mounting foot print area. Though not shown, the turbine generator (5) would preferably be located and mounted in the interior space of the housing (1V) in a position that allows for the utilization of 90 or 45 degree pipe sweeps rather than 90 degree elbows or street ells. Utilizing pipe sweeps rather than couplings or adaptors that make hard 90 degree turns or bends in the pipe will minimize pressure loss normally attributable in such designs. Again, similar to FIG. 2, the hydroelectric turbine generator can be mounted either within the housing (1V) attaching to an interior wall by the use of a mounting bracket (6) or other mounting hardware design, or can simply be supported by the pipe (11) and (12) the turbine (5) is connected and functioning with, or can be located or position within the below grade mounting base portion (4). Positioning the turbine (4) within the interior space of the below grade housing portion (4) would increase usable interior space within the housing structure (1V) to permit the placement and implementation of additional electronic equipment or other devices that would benefit from the increase in interior volumetric area. The housing structure (1V) is preferably bolted down to or otherwise in physical connection with the mounting base (3VB), and wherein said mounting base (3VB) is bolted down or otherwise in physical connection with said below grade mounting base (4), and wherein said below grade mounting base (4) is positioned within a hole or excavation made below ground level (19), and said hole or excavation is backfilled and compacted to securely fastened the base in the ground once the housing assembly structure (1H) has been attached, and wherein said mounting base (3VB) is positioned at or above grade level (19), and wherein said housing structure (1V) is positioned in a vertical orientation above the mounting base (3VB). In one preferred embodiment, the housing structure (1V) includes a top hatch or lid (2) that can be connected to said housing structure (1V) via hinges for convenient access into the interior space of the housing or by removable or detachable hardware that permits the complete removal of the lid or hatch (2). Access doors or removable panels (not shown) can be incorporated on any of the vertical sides of the housing structure (1V) to permit access into interior compartments or partitions. The lid (2) can serve as the mounting structure or point where solar collection panels (7) can be removably or permanently affixed, and can include an angled top portion from the vertical orientation of the housing structure (1V) so as to allow the solar panel better reception or position in regards to the sun to maximize solar energy electric production, Said solar panels (7), which can include an optional transparent protective material (8) can be mounted either beneath the lid cover (2) or on top of it (not shown). Additionally, the housing structure (1V) can be adapted to accommodate a mast structure, as shown and explained in FIG. 1, that allows for the convenient addition of additional solar panel units and optionally a wind turbine electric generator. The vertical housing structure (1V) can also accommodate electronic devices that monitor and control the overall system operation, like charge controllers (17), voltage and current regulators (16), inverters (15) or other specialized power supplies or SCADA system devices or other electronic devices that would receive power from this invention. The hydroelectric turbine generator (5) produces electric energy as fluid flows through it and conveys that energy via a wire or cable path to a voltage regulator and/or inverted if the regulator is integrated into the turbine. Similarly, solar collector panels (7) and wind turbine generator (not shown) would also provide electric energy when solar or wind conditions are suitable and potentially when hydroelectric turbine power is unavailable and would also be in wire or cable path communication with a voltage regulator or controller.

Both VAC or VDC electric voltage and current can be produced depending upon the requirement by implementing appropriate electronic hardware like inverters or transformers. In the preferred embodiment, energy from the turbine (5) and solar panels (7) or wind turbine (not shown) would be directed to a battery (10) for storage and use by any electronic devices that are supplied power by this invention. FIG. 3, by way of illustration and not limitation, explains the implementation of both hydroelectric turbine and solar power energy production and storage, but excludes wind turbine electric power production.

It will be appreciated by those skilled in the art, that the invention is herein described with reference to certain examples or preferred embodiments as shown in the drawings. Various additions, deletions, changes and alterations may be made to the above-described embodiments and examples without departing from the intended spirit and scope of this invention which is to provide a single unitized structure or assembly that enables the convenient implementation of hydroelectric turbine generated power, solar power and wind turbine power optionally. Accordingly, it is intended that all such additions, deletions, changes and alterations be included within the scope of the following claims.

What is claimed is:

1. A unitized electric generator and storage system assembly apparatus is provided that produces and stores electric energy derived from renewal sources that comprises:
an electrical energy generating means;
a housing apparatus chassis comprising a mounting base structure, a removable protective covering shroud with interior and exterior portions, a mounting chassis structure having wall sections connecting to and perpendicular to said shroud, and at least one sealable opening that permits exterior to interior physical access of componentry contained internally to said housing apparatus chassis and where said electrical energy generating means are located therein or thereupon said chassis; and,
a mounting apparatus, contained internally onto said mounting chassis structure, having a location to attach controls for said electrical energy generating means, routed electrical cabling to convey electricity and data from one point within said housing to another and to said housing exterior, at least one location for at least one capacitive electrical energy storage device, at least one location for at least one electronic control apparatus and circuitry that monitors sensor inputs and said control apparatus capable of performing preprogrammed automated control outputs.

2. A unitized electric generator and storage system assembly apparatus is provided that produces and stores electric energy derived from renewal sources as in claim 1 wherein said housing apparatus chassis is a vault box structure that includes a base portion connected to vertical wall surfaces, a sealable top cover which is located atop and above the said vault vertical walls, establishing a covered interior and open air volumetric space within said vault and wherein said top is further positioned above the exterior surrounding grade or ground surface level.

3. A unitized electric generator and storage system assembly apparatus is provided that produces and stores electric energy derived from renewal sources as in claim 2 wherein said base portion does not possess a separate bottom portion but uses available soil or other porous natural materials such as sand, gravel or rock as said base portion, said vertical wall surfaces and said top cover positioned directly onto said soil.

4. A unitized electric generator and storage system assembly apparatus is provided that produces and stores electric energy derived from renewal sources as in claim 1 where said electrical energy generating means are selected from a group consisting of a hydroelectric turbine generator system, a photovoltaic collection panel of solar energy, or atmospheric wind blown energy or combinations of at least two of thereof means, whereby said hydroelectric turbine generator system utilizes fluid flowing through an enclosed pipe under hydraulic pressure providing energy which turns the turbine that makes the production of electric voltage and current, and whereby said photovoltaic collection panels convert sun or light energy into electricity and whereby said atmospheric wind blown energy is collected using a wind turbine generator device that converts wind energy or atmospheric movement and subsequent pressure that turns a series of blades or propellers which rotate on a shaft that converts rotational energy into electricity.

5. A unitized electric generator and storage system assembly apparatus is provided that produces and stores electric energy derived from renewal sources as in claim 1 wherein said housing is positioned in close proximity to at least one pipe line that contains a fluid that flows under hydraulic pressure, and wherein said pipe line is in physical connection to said hydroelectric turbine generator device contained within said housing.

6. A unitized electric generator and storage system assembly apparatus is provided that produces and stores electric energy derived from renewal sources as in claim 5 wherein at least one control valve and flow and pressure sensors are in physical connection with said pipe line and in electrical connection within said electronic control apparatus.

7. A unitized electric generator and storage system assembly apparatus is provided that produces and stores electric energy derived from renewal sources as in claim 1 where said removable protective covering shroud includes a structure that serves as a mounting apparatus for said photovoltaic energy generating means and a shielding cover that is positioned onto the exterior of said protective covering shroud and is in physical connection therewith as an integrated, adapted and removable part of said removable protective covering shroud.

8. A unitized electric generator and storage system assembly apparatus is provided that produces and stores electric energy derived from renewal sources as in claim 5 wherein connection is made between said fluid flow pipe line and said hydroelectric turbine, inlet and outlet discharge sections, through the use of pipe unions, slip or threaded couplings, compression couplings, hoses, quick connect or disconnect couplings or any other device, proprietary or otherwise, that can be used to connect pipes together to form a sealed joint that prohibits interior fluid from escaping to the exterior, and all contained with said housing chassis structure.

9. A unitized electric generator and storage system assembly apparatus is provided that produces electric energy derived from a combination of power generating means as in claim 7 wherein said removable protective covering shroud is adapted to serve as said chassis housing structure to affix or mount at least one photovoltaic energy generating panel, and further provides for secure and protected attachment of the same, said panel electrically connected to said electronic control apparatus.

10. A unitized electric generator and storage system assembly apparatus is provided that produces electric energy derived from a combination of power generating means as in claim 1 wherein at least one mast and cabling are attached to said exterior portion of said mounting chassis structure that is designed to removeably attach said mast, said mast having an proximal portion and a distal portion.

11. A unitized electric generator and storage system assembly apparatus is provided that produces electric energy derived from a combination of power generating means as in claim 10; wherein said mast and cabling provide a means to attach at least one atmospheric wind turbine electrical energy generator to distal portion of said mast.

12. A unitized electric generator and storage system assembly apparatus is provided that produces electric energy derived from a combination of power generating means as in claim 10; wherein said mast and cabling provide a means to attach at least one solar panel, at least one atmospheric wind turbine generator, and at least one atmospheric sensor to distal portion of said mast.

13. A unitized electric generator and storage system assembly apparatus is provided that produces electric energy derived from a combination of power generating means as in claim 10; wherein said mast is attached to said housing using multiple detachable mounting points, and a single pivot point located at the proximal portion of said mast, said pivot allowing said mast to be erected vertically for normal operation and lowered to provide for servicing.

14. A unitized electric generator and storage system assembly apparatus is provided that produces electric energy derived from a combination of power generating means as in claim 1 wherein said electronic control apparatus consists of a digital processor, digital and analog circuitry and components that perform automated monitoring and control of critical functions of said electrical energy generating means, interior and exterior ambient temperatures, capacitive electrical energy storage device, output voltage and current load demand of facilities, devices or equipment consuming energy supplied by said unitized electric generator and storage system assembly apparatus, said electronic control apparatus are connected using wires or are connected wirelessly.

15. A unitized electric generator and storage system assembly apparatus is provided that produces electric energy derived from a combination of power generating means as in claim 1 wherein said housing assembly can be adapted to accommodate the addition and integration of additional housing sections.
